(19) United States
(12) Patent Application Publication
(10) Pub. No.: US 2012/0021895 A1
(43) Pub. Date: Jan. 26, 2012

(54) HONEYCOMB CATALYST SUBSTRATE AND METHOD FOR PRODUCING SAME

(75) Inventors: Philippe Auroy, Gif-Sur-Yvette (FR); Ahmed Marouf, Cavaillon (FR); Damien Philippe Mey, Cavaillon (FR)

(73) Assignee: SAINT-GOBAIN CENTRE DE RECHERCHES ET D'ETUDES EUR., Courbevoie (FR)

(21) Appl. No.: 13/259,273

(22) PCT Filed: Apr. 14, 2010
(86) PCT No.: PCT/FR2010/050720

§ 371 Date: Oct. 3, 2011

(30) Foreign Application Priority Data
Apr. 16, 2009 (FR) 0952493

(51) Int. Cl. B01J 31/06; B01J 31/38; B01J 31/26

(52) U.S. Cl. 502/62; 502/439; 502/159

(57) ABSTRACT

The subject of the invention is a catalyst support made of a porous inorganic material, for the treatment of exhaust gases, having a honeycomb structure, one of the faces of the structure serving for the intake of the exhaust gases to be treated and the other face serving for the discharge of the treated exhaust gases, which structure comprises, between these intake and discharge faces, an array of adjacent ducts or channels of mutually parallel axes separated by porous walls, said support being coated on at least part of its internal surface with at least one vinylpyrrolidone polymer or copolymer.

The invention relates to the field of catalyst supports made of a porous inorganic material for the treatment of exhaust gases, in particular those coming from internal combustion engines, especially from motor vehicles, for example from diesel engines. These supports have a honeycomb structure, one of the faces of the structure serving for the intake of the exhaust gases to be treated and the other face serving for discharging the treated exhaust gases, which structure comprises, between these intake and discharge faces, an array of adjacent ducts or channels of mutually parallel axes separated by porous walls. The channels can alternately be sealed off at one or other of the ends of the structure so as to filter out the particulates or soot particles contained in the exhaust gases. In this way, a filter structure usually called a particulate filter is obtained.

Certain inorganic materials, such as for example aluminum titanate (Al₂TiO₅ or cordierite, have a very low thermal expansion up to temperatures of about 800° C. This advantageous characteristic is due to the presence of microcracks in the ceramic grains. During heating, the intrinsic expansion of the material firstly causes the microcracks to close up, but without macroscopic expansion of the support. Thanks to this low thermal expansion, it is possible to employ supports or filters that are monolithic, i.e. made of a single ceramic block.

However, depositing catalytic coatings on the surface of the porous walls of the honeycombs generally leads to these microcracks being sealed off, so that the thermal expansion of the substrate or filter is thereby increased. The presence of the catalyst will in fact prevent the microcracks from closing up.

Several solutions to this problem have been proposed, but none of them is without drawbacks. These solutions consist in depositing polymeric compounds on the surface of the support before the catalytic coating is deposited, a technique referred to as “passivation”.

Patent application US 2006/183632 thus proposes passivating the surface of the support using gelatin or vinyl alcohol/vinylamine copolymers or vinyl alcohol/vinyl formamide copolymers. Crosslinking agents are generally added. The passivation layer is then calcined at the same time as the catalytic coating. However, this solution results in a low affinity of the catalytic coating for the support, and therefore reduces the amount of catalyst that can be fixed to the support. Furthermore, calcining the crosslinking agents generates often toxic gaseous effluents that have to be reprocessed.

Patent application DE 10 2007 023120 proposes depositing silanes that will be converted to silicones by crosslinking. However, decomposition of the silicones during calcination generates a large amount of gaseous effluents and creates silica that seals off the microcracks, hence an increase in the thermal expansion coefficient.

One object of the invention is to obviate these various drawbacks by providing a passivation method that is more environmentally friendly. Another object of the invention is to obtain better affinity (before and after calcination) between the support or the passivation layer and the catalytic coating that is deposited after the passivation step. Another object of the invention is to limit the increase in the macroscopic expansion coefficient of the support provided with its catalytic coating.

For this purpose, one subject of the invention is a catalyst support made of a porous inorganic material, for the treatment of exhaust gases, having a honeycomb structure, one of the faces of the structure serving for the intake of the exhaust gases to be treated and the other face serving for the discharge of the treated exhaust gases, which structure comprises, between these intake and discharge faces, an array of adjacent ducts or channels of mutually parallel axes separated by porous walls, said support being coated on at least part of its internal surface with at least one vinylpyrrolidone polymer or copolymer.

Another subject of the invention is a process for obtaining a catalyst support made of a porous inorganic material according to the invention, comprising a step in which a vinylpyrrolidone polymer or copolymer is deposited on said support, followed by a drying step.

The use of polyvinylpyrrolidone (PVP)-based polymers as passivation material has several advantages.

No crosslinking agent or curing agent is necessary, as these polymers self-crosslink during drying. The process is therefore more rapid and less expensive, and also more environmentally friendly since it involves the use of nontoxic substances and reduces the problem of gaseous effluents during calcination.

The chemical affinity between the catalytic coating and the support is furthermore improved over the solutions of the prior art. This better affinity makes it possible to subsequently fix a larger amount of catalyst per unit area and to obtain a more uniform catalytic coating (or washcoat) i.e. better distributed over the surface, and therefore a greater catalytic efficiency for the same surface area of the support.

Polyvinylpyrrolidone-based polymers are particularly suitable for passivating a support on which would subsequently be deposited a catalytic coating having, after calcination, very small crystallites, particularly with a size of less than 20 nm, so as to increase the catalytic performance of the coating. This type of coating, for example deposited in boehmite form, has however the drawback of easily infiltrating into the microcracks of the support.

Polyvinylpyrrolidone-based polymers have also proved to be better passivating materials than those known from the prior art. When deposited on the support before any catalytic coating is deposited, they make it possible to limit the increase in thermal expansion coefficient due to the infiltration of the catalyst into the microcracks of the ceramic grains of the support.

Preferably, the channels are alternately sealed at one or other of the ends so as to filter out the particulates or soot particles contained in the exhaust gases. The support obtained is then a particulate filter provided with a catalytic component, making it possible for example to eliminate polluting gases of the following types: NOₓ, carbon monoxide (CO) or unburnt hydrocarbons (HC).

Preferably, the porous inorganic material is chosen from aluminum titanate, cordierite and mullite. Other materials may also be used, such as for example silicon carbide or sintered metals. The expression “aluminum titanate” is understood to mean not only aluminum titanate by itself, of formula Al₂TiO₅, but also any material based on aluminum titanate, in particular any material comprising at least 70%, or 80% and even 90% of an aluminum titanate phase, it being possible, optionally, for the titanium and aluminum atoms to be partially substituted, especially with silicon, magnesium or else zirconium atoms. As examples, the aluminum titanate may contain a minor phase of the mullite type, as taught in patent application WO 2004/011124, or of the feldspar type, as taught in patent application EP 1 559 696. Examples of materials are also given in patent applications WO 2009/156652, WO 2010/001062, WO 2010/001064, WO 2010/001065 and WO 2010/001066.

The vinylpyrrolidone polymer or copolymer is preferably chosen from polyvinylpyrrolidone, vinylpyrrolidole/vinyl acetate copolymers, vinylpyrrolidone/vinylimidazone copolymers and vinylypyrrolidone/vinylcaprolactam copolymers, or any one of their blends. Preferably, no crosslinking agent is added.

The support according to the invention may also be coated on at least part of its internal surface with at least one silane-type compound, especially a silane-type compound having at least one carbon chain possessing at least one nucleophilic group. This compound is in general deposited at the same time as the vinylpyrrolidone polymer or copolymer. It allows better grafting of the vinylpyrrolidone polymer or copolymer onto the porous ceramic support. Upon adding the silane, the alkoxide groups of the silane are hydrolyzed by the hydroxyl groups present on the surface of the support and bond to this surface. The silane having at least one carbon chain possessing at least one nucleophilic group can link the other end of the grafted silane to the vinylpyrrolidone polymer or copolymer by reacting with the carbonyl groups of the latter.

The silane having at least one carbon chain possessing at least one nucleophilic group is especially of the Nu-R₁—Si—(OR₂)₃ type in which R₁ and R₂ are alkyl radicals and the nucleophilic group Nu may be chosen from NH₂, SH and OH groups. The silane may be added to the aqueous polymer or copolymer solution or to a water/alcohol mixture so as to make it easier to disperse and to limit its hydrolysis.

Preferably, the vinylpyrrolidone polymer or copolymer is deposited by impregnation of a liquid, especially aqueous, solution or dispersion. The weight content of vinylpyrrolidone polymer or copolymer in the solution or dispersion is advantageously between 1 and 30%, preferably between 5 and 15%. The average molecular weight of the vinylpyrrolidone polymer or copolymer, especially at the moment of deposition, is preferably between 10,000 and 1,000,000 g/mol, especially between 15,000 and 500,000 g/mol, or between 15,000 and 400,000 g/mol, or else between 15,000 and 300,000 g/mol or even between 20,000 and 10,0000 g/mol. These various parameters—weight content in the solution or dispersion and average molecular weight—serve to adjust the viscosity of the solution or dispersion, and therefore the penetration of the polymer into the microcrack of the support. It has been observed that for high molecular weights, typically 1,000,000 or higher, the amount of catalytic coating that can be subsequently fixed to the support decreases substantially. The average molecular weight of the vinylpyrrolidone polymer or copolymer is therefore preferably less than 1,000,000 g/mol.

The impregnation may be carried out in particular by dipping the substrate and/or by vacuum impregnation. In the latter case, the substrate may be placed in a desiccater under a pressure of 25 mbar or lower and the polymer solution or dispersion poured onto the support.

After impregnation, the excess solvent, especially water, may be removed, for example by blasting with a gas such as air, or by applying a reduced pressure, for example a pressure of less than 100 mbar, at one end of the support.

To optimize the adhesion of the catalytic coating to the support, the drying step is preferably carried out at a temperature of at least 100° C., especially between 130 and 170° C. or even between 130 and 160° C. For lower temperatures, the adhesion of the polymer to the support is weaker. The polymer is more soluble in water and risks being dissolved during deposition of the catalytic coating. Excessively high temperatures, especially above 180° C. or even 190° C., risk stiffening the polymer and creating mechanical stresses within the support, particularly during deposition of the catalytic coating. It has also been observed that these high drying temperatures have the effect of reducing the amount of catalytic coating that can be subsequently fixed to the support.

The support according to the invention is preferably coated on at least part of its surface with a catalytic coating. This coating is deposited on the surface of the walls of the support or of the filter after the passivation step. Preferably, it comprises a base material and a catalyst. The base material is generally an inorganic material of high specific surface area (typically of the order of 10 to 100 m²/g) ensuring dispersion and stabilization of the catalyst. Advantageously, the base material is chosen from alumina, zirconia, titanium oxide, rare-earth oxides, such as cerium oxide, and alkali metal or alkaline-earth metal oxides. Preferably, the catalyst is based on a noble metal, such as platinum, palladium or rhodium, or based on transition metals.

The particle size of the base material on which the catalyst particles are disposed generally range from around a few nanometers to a few tens of nanometers, or exceptionally a few hundred nanometers.

The process according to the invention is therefore preferably followed by a step of depositing a catalytic coating and then by a calcination step, typically carried out in air and between 300 and 900° C., preferably between 400 and 600° C.

The subject of the invention is also a catalyst support that can be obtained by this preferred process.

Before calcination, the support according to the invention has a polymer layer (the vinylpyrrolidone polymer or copolymer) on its surface. This polymer layer is removed during calcination. However, its presence makes it possible to obtain a calcined support that differs from the known supports of the prior art.

The polymer layer may especially be identified, before calcination, using the following two methods:
by thermogravimetric analysis coupled to a mass spectrometer so as to identify the decomposition products of the deposited polymer;
by extraction, for example by leaching, followed by chromatography analysis optionally coupled to a mass spectrometer.

The catalytic coating is typically deposited by impregnating a solution comprising the base material or its precursors and a catalyst, or a precursor of this catalyst. In general, the precursors used take the form of organic or mineral salts or compounds that are dissolved or suspended in an aqueous or organic solution. The impregnation is followed by a calcination heat treatment so that the final coating comprises a catalytically active solid phase in the pores of the support or filter.

Such processes, together with the devices for implementing them, are for example described in the following patent applications or patents: US 2003/044520, WO 2004/091786, U.S. Pat. No. 6,149,973, U.S. Pat. No. 6,627,257, U.S. Pat. No. 6,478,874, U.S. Pat. No. 5,866,210, U.S. Pat. No. 4,609,563, U.S. Pat. No. 4,550,034, U.S. Pat. No. 6,599,570, U.S. Pat. No. 4,208,454 and U.S. Pat. No. 5,422,138.

The catalyst supports or catalytic filters according to the invention may be used in the exhaust line of an internal combustion engine, typically a diesel engine. To do this, the catalyst supports or catalytic filters may be encased in a fibrous mat and then inserted into a metal can, frequently called “canning”. The fibrous mat is preferably formed from inorganic fibers so as to confer the requisite thermal insulation properties for the application. The inorganic fibers are preferably ceramic fibers, such as alumina, mullite, zirconia, titanium oxide, silica, silicon carbide or silicon nitride fibers, or else glass fibers, such as R-glass fibers. These fibers may be obtained by fiberizing starting with a bath of molten oxides, or starting from a solution of organometallic precursors (sol-gel process). Preferably, the fibrous mat is non-intumescent and advantageously takes the form of a needle-punched felt.

The invention is nonlimitingly illustrated by the following examples, in which all the percentages are percentages by weight.

Using the method described above, porous aluminum titanate supports are obtained.

In a preliminary step, aluminum titanate was prepared from the following raw materials:
about 40% alumina by weight, with an Al₂O₃ purity level greater than 99.5% and a median diameter d₅₀ of 90 μm, sold under the reference AR75® by Pechiney;
about 50% titanium oxide by weight, in rutile form, comprising more than 95% TiO₂ and about 1% zirconia and having a median diameter d₅₀ of about 120 μm, sold by Europe Minerals;
about 5% silica by weight, with an SiO₂ purity level greater than 99.5% and a median diameter d₅₀ of around 210 μm, sold by SIFRACO; and
about 4% by weight of a magnesia powder with an MgO purity level greater than 98%, more than 80% of the particles of which having a diameter between 0.25 and 1 mm, sold by Nedmag.

The initial blend of reactive oxides was melted in an electric arc furnace, in air, under oxidizing electrical operation. The molten mixture was then cast into a CS mold so as to achieve rapid cooling. The product obtained was milled and screened in order to obtain powders of various particle size fractions. More precisely, the milling and screening operations were carried out under conditions for obtaining in the end the following two particle size fractions:
one particle size fraction characterized by a median diameter d₅₀ substantially equal to 50 microns, denoted by the term “coarse”; and
one particle size fraction characterized by a median diameter d₅₀ substantially equal to 1.5 microns, denoted by the term “fine” fraction.

In the context of the present description, the median diameter d₅₀ denotes the particle diameter, measured by sedigraphy, below which 50% by volume of the population lies.

Microprobe analysis showed that all the grains of the fused phase thus obtained have the composition, in percentages by weight of the oxides below, reproduced in Table 1:

TABLE 1

| Al₂O₃ | TiO₂ | MgO | SiO₂ | CaO | Na₂O | K₂O | Fe₂O₃ | ZrO₂ | TOTAL |
|---|---|---|---|---|---|---|---|---|---|
| 40.5 | 48.5 | 3.98 | 4.81 | 0.17 | 0.15 | 0.47 | 0.55 | 0.85 | 100.00 |

The particles thus obtained were then used to manufacture green monoliths (substrates).

Powders according to the following composition were blended in a mixer:
100% of a blend of two aluminum titanate powders produced beforehand by fuse casting, namely about 75% of a first powder with a median diameter of 50 μm and 25% of a second powder with a median diameter of 1.5 μm.

Next, the following were added, relative to the total mass of the blend:
4% by weight of an organic binder of the cellulose type;
15% by weight of a pore-forming agent;
5% of a plasticizer derived from ethylene glycol;
2% of a lubricant (oil);
0.1% of a surfactant; and
about 20% of water so as to obtain, using the techniques of the art, a homogenous paste after mixing, the plasticity of which enabled a honeycomb structure to be extruded through a die, which structure, after being fired, had the dimensional characteristics as in Table 2.

Next, the green monoliths obtained were dried by microwave drying for a time sufficient to bring the chemically unbound water content to less than 1% by weight.

The channels of both ends of the monoliths were plugged using well-known techniques, for example those described in U.S. Pat. No. 4,557,773, with a mixture satisfying the following formulation:
100% of a blend of two aluminum titanate powders produced beforehand by fuse casting, namely about 66% of a first powder with a median diameter of 50 μm and 34% of a second powder with a median diameter of 1.5 μm;
1.5% of an organic binder of the cellulose type;
21.4% of a pore-forming agent;
0.8% of a dispersant based on a carboxylic acid; and
about 55% of water so as to obtain a mixture capable of sealing the monoliths on every other channel.

The characteristics of the monoliths (support), after progressive firing in air until a temperature of 1450° C. was reached, this temperature being maintained for 4 hours, are given below in Table 2:

TABLE 2

| Monolith shape | square | |
|---|---|---|
| Width | 33 | mm |
| Length | 152.4 | mm |
| Cell cross section | square | |
| Cell concentration | 33 | cells/cm² |
| Wall thickness | 350 | μm |
| Constituent material of the | essentially aluminum | |
| filtering walls and the | titanate phase | |
| plugs | | |
| Porosity | 44% | |
| Median pore diameter | 13 | μm |

| | |
|---|---|
| Average thermal expansion | 1.3 × 10⁻⁶/° C. |
| coefficient between 65 and | |
| 1000° C. | |

The porosity characteristics were measured by high-pressure mercury porosimetry analysis carried out using a Micromeritics 9500 porosimeter.

The monoliths were then impregnated by immersing them in a solution containing the polymer, and then dried.

In the case of comparative examples C1 to C5, the polymer used was a polyvinyl alcohol sold by Celanese Corporation under the reference Celvol 205. Its degree of hydrolysis was greater than 880. In the case of comparative examples C4 and C5, the polymer was crosslinked using citric acid.

Comparative example C6 corresponded to an unpassivated monolith (therefore one with no polymer deposited).

In the case of examples 1 and 2, the polymer was a polyvinylpyrrolidone having an average molecular weight of 58,000 g/mol.

In the case of examples 3 to 7, the polymer was a polyvinylpyrrolidone having an average molecular weight of 30,000 g/mol. The solution employed is sold by BASF under the reference Luvitec K30. For example 4, the solution was brought to a pH of 10 by adding NaOH.

Table 3 below indicates:
the drying time and the drying temperature, denoted by t and T respectively;
the concentration of the impregnation solution, denoted by C and expressed as a percentage by weight of polymer relative to the amount of solution;
the amount of polymer (passivating material) actually deposited, as a percentage by weight, denoted by Q;
the water uptake after passivation, denoted by P, expressed as a percentage by weight;
the alumina uptake, denoted by A, expressed as a percentage by weight; and
the average thermal expansion coefficient of the support provided with its catalytic coating, denoted by TEC and expressed in 10⁻⁶/° C.

The water uptake after passivation was used to estimate the amount of catalyst that could be fixed to the support, and therefore the affinity between the support and the future catalytic coating. The measurement method consisted in immersing the passivated support in water and then in subjecting one of its ends to a sudden suction operation so as to leave only a film of water on the surface of the walls. A high residual amount of water is characteristic of a strong chemical affinity between the future catalytic coating and the support, and therefore of the possibility of fixing more catalytic coating. Such a method is described in patent application EP 1 462 171.

The alumina uptake (A) was measured in the following manner: a 20 wt % boehmite solution was prepared by suspending 200 g of boehmite (Dispersal® supplied by Sasol) in 1 liter of distilled water, the solution being acidified by adding concentrated (52%) nitric acid until reaching a pH of 2 and the dispersion being obtained by vigorous stirring for 2 hours. The monolith was then impregnated by immersing it in this solution for 1 minute and the excess solution present on the monolith was removed by blasting it with compressed air. The part was then dried in air at 120° C. for 2 hours and then calcined for 2 hours at 500° C. in air in order to form an alumina coating. The alumina uptake corresponded to the increase in mass corresponding to the alumina coating.

The average thermal expansion coefficient (TEC) was measured between 65° C. and 1000° C. by differential dilatometry with a temperature rise of 5° C./minute according to the NF B40-308 standard. The material specimen tested was obtained by cutting it out from the honeycomb in a plane parallel to the extrusion direction of the monolith. Its dimensions were approximately 5 mm×5 mm×15 mm. The measurements were carried out after boehmite deposition and calcination in order to simulate the effect of a catalytic coating having crystallites of very small size after calcination, i.e. of the order of 10 nm.

The weight gains or weight losses (Q, P, A) are expressed as percentages by weight relative to the weight of the dry support before impregnation.

TABLE 3

| | t | T | | | | | |
|---|---|---|---|---|---|---|---|
| | (hours) | (° C.) | C | Q | P | A | TEC |
| C1 | 3 | 105 | 10 | 2.3 | 11 | | |
| C2 | 3 | 105 | 5 | 1.4 | 14 | | |
| C3 | 3 | 105 | 2 | 0.5 | 16 | 2.0 | 4.5 |
| C4 | 3 | 105 | 5 | 1.5 | 7 | | |
| C5 | 3 | 105 | 2 | 0.7 | 8 | | |
| C6 | — | — | — | 0 | 23 | 2.8 | 5.3 |
| 1 | 3 | 105 | 5 | 0.9 | 25 | | |
| 2 | 3 | 105 | 2 | 0.3 | 25 | | |
| 3 | 3 | 105 | 10 | 2.6 | 23 | | |
| 4 | 3 | 105 | 10 | 2.7 | 23 | | |
| 5 | 1 | 130 | 10 | 2.7 | 25 | | |
| 6 | 1 | 150 | 10 | 4 | 26 | | |
| 7 | 1 | 160 | 10 | 2.3 | 25 | 2.9 | 3.1 |

These results show that the use of polyvinylpyrrolidone in place of polyvinyl alcohol considerably improves the affinity between the support and the catalytic coating deposited after passivation. The reason for this is that the level of water uptake of the examples according to the invention is much higher than that of examples C1 to C5 and very similar to that of the unpassivated structure.

The passivating effect of the polyvinylpyrrolidone, illustrated by example 7, is particularly advantageous since the thermal expansion coefficient of the support which is passivated and then provided with its catalytic coating is decreased by more than 40% relative to an unpassivated support (example C6) before the catalytic coating is deposited. The passivating effect of the polyvinylpyrrolidone is also better than that of polyvinyl alcohol (example C3).

Table 4 below illustrates the influence of the drying temperature on the adhesion of the polymer to the support.

Unlike example 7, examples 9 and 11 were dried at 170° C. and 190° C. respectively.

Unlike examples 7 and 9, in examples 8 and 10 respectively, 3-aminopropyltrimethoxysilane (of 99% purity supplied by Sigma Aldrich) was added to the solution in an amount of 5% by weight relative to the weight of polyvinylpyrrolidone.

In addition to the parameters already described, Table 4 includes the parameter denoted by L, which corresponds to the weight loss after the dried support is immersed in water for one minute at room temperature and then dried at 105° C. in air.

TABLE 4

| | t | T | C | Q | P | L |
|---|---|---|---|---|---|---|
| | (hours) | (° C.) | (wt %) | (wt %) | (wt %) | (wt %) |
| 3 | 3 | 105 | 10 | 2.6 | 23 | 2.5 |
| 5 | 1 | 130 | 10 | 2.7 | 25 | 1.2 |
| 7 | 1 | 160 | 10 | 2.3 | 25 | 0.6 |
| 8 | 1 | 160 | 10 | 2.4 | 26 | 0.3 |
| 9 | 1 | 170 | 10 | 2.5 | 22 | 0.6 |
| 10 | 1 | 170 | 10 | 2.7 | 21 | 0.2 |
| 11 | 1 | 190 | 10 | 2.8 | 17 | 0.2 |

These results show that a higher drying temperature results in better adhesion of the passivating polymer layer to the support, since the weight loss (L) after immersion of the support decreases when the drying temperature increases. However, this also results in a reduction in the affinity with the future catalytic coating for the highest drying temperatures, since the water uptake (P) after passivation also decreases when the drying temperature increases. Consequently, a drying temperature between 130 and 170° C., or indeed between 130 and 160° C., constitutes an optimum.

Comparison of examples 8 and 10 with examples 7 and 9 respectively shows that the addition of a small amount of silane further improves the adhesion of the polymer layer to the support.

1. A catalyst support, comprising a porous inorganic material,
wherein the support is suitable for the treatment of at least one exhaust gas and has a honeycomb structure,
wherein one face of a structure of the catalyst support, an intake face, serves for intake of the at least one exhaust gas to be treated and a discharge face serves for a discharge of treated exhaust gases,
wherein the structure comprises, between the intake and discharge faces, an array of adjacent ducts or channels of mutually parallel axes separated by porous walls, and
wherein the support is coated on at least part of an internal surface of the support with at least one vinylpyrrolidone polymer or copolymer.

2. The support of claim 1, wherein the channels are alternately sealed at one or another end so as to filter out at least one particulate or soot particle comprised in the at least one exhaust gas.

3. The support of claim 1, wherein the porous inorganic material is at least one selected from the group consisting of aluminum titanate, cordierite, and mullite.

4. The support of claim 1, wherein the vinylpyrrolidone polymer or copolymer is at least one selected from the group consisting of polyvinylpyrrolidone, a vinylpyrrolidone/vinyl acetate copolymer, a vinylpyrrolidone/vinylimidazole copolymer, and a vinylypyrrolidone/vinylcaprolactam copolymer.

5. The support of claim 1, wherein the internal surface of the support is coated, at least partially with at least one silane compound.

6. The support of claim 1, wherein a surface of the support is coated, at least partially with a catalytic coating.

7. The support of claim 6, wherein the catalytic coating comprises a base material and a catalyst.

8. The support claim 7, wherein the base material is an inorganic material having a specific surface area of 10 to 100 m²/g.

9. A process for obtaining the catalyst support of claim 1, the process comprising:
depositing a vinylpyrrolidone polymer or copolymer on the support; followed by
drying.

10. The process of claim 9, wherein the vinylpyrrolidone polymer or copolymer is deposited by impregnation of a liquid solution or dispersion.

11. The process of claim 10, the wherein a weight content of vinylpyrrolidone polymer or copolymer in the solution or dispersion is between 1 and 30%.

12. The process of claim 9, wherein an average molecular weight of the vinylpyrrolidone polymer or copolymer is between 10,000 and 1,000,000 g/mol.

13. The process of claim 9, wherein the drying is carried out at a temperature of at least 100° C., especially between 130 and 170° C.

14. The process of claim 9, f further comprising, after the drying:
depositing a catalytic coating onto the support; and then
calcinating.

15. A catalyst support, obtained by the process of claim 9.

16. The support of claim 5, wherein the silane compound comprises at least one carbon chain comprising at least one nucleophilic group.

17. The process of claim 10, wherein the solution or dispersion is aqueous.

18. The process of claim 10, wherein a weight content of vinylpyrrolidone polymer or copolymer in the solution or dispersion is between 5 and 15%.

19. The process of claim 9, wherein an average molecular weight of the vinylpyrrolidone polymer or copolymer is between 20,000 and 100,000 g/mol.

20. The process of claim 9, wherein the drying is carried out between 130 and 170° C.
